(19) United States
(12) Patent Application Publication
(10) Pub. No.: US 2018/0173493 A1
(43) Pub. Date: Jun. 21, 2018

(54) SPEECH-ASSISTED TEST SYSTEM AND METHOD

(71) Applicants: HONGFUJIN PRECISION ELECTRONICS (TIANJIN) CO.,LTD., Tianjin (CN); HON HAI PRECISION INDUSTRY CO., LTD., New Taipei (TW)

(72) Inventors: CHAO-BIN CHEN, New Taipei (TW); WEI-YI WANG, Shenzhen (CN); WEI YU, Shenzhen (CN); XIAO-MENG SHI, Shenzhen (CN); JIE-MING PAN, Shenzhen (CN); TONG DUAN, Shenzhen (CN)

(21) Appl. No.: 15/431,896

(22) Filed: Feb. 14, 2017

(30) Foreign Application Priority Data
Dec. 17, 2016 (CN) 201611171611.8

(51) Int. Cl. G06F 3/16; G09B 19/00; G09B 5/06

(52) U.S. Cl. CPC G06F 3/167; G09B 5/06; G09B 19/00

(57) ABSTRACT

A speech-assisted test system employed in an electronic device assists the hands-free testing of a product by a tester and includes an activating module, a text importing module, a speech converting module, and a speech controlling module. On activating the speech-assisted test system operation, the activating module displays an interactive interface on a display of the electronic device. The text importing module imports testing manual of a testing procedure when an import testing manual command is given through the interactive interface. The speech converting module converts the contents in the testing manual to speech. According to a speech controlling operation on the interactive interface, the speech controlling module controls the playback of the speech file on command the speech file. A speech-assisted test method is also disclosed.

### CROSS-REFERENCE TO RELATED APPLICATIONS

This application claims priority to Chinese Patent Application No. 201611171611.8, filed on Dec. 17, 2016, the contents of which are incorporated by reference herein.

### FIELD

The subject matter herein generally relates to testing systems.

### BACKGROUND

When testing products, a tester should read a manual or relevant literature for the product to get an idea of how to test the product. The product generally has a number of testing steps or built in mechanisms to relay the condition or present state of the product to the tester. From the information gathered in the testing phase of the product, the tester can ascertain the condition of the product. The tester generally has to read through numerous steps to test the condition of the product, which can be an inefficient and time consuming process.

### BRIEF DESCRIPTION OF THE DRAWINGS

Implementations of the present disclosure will now be described, by way of example only, with reference to the attached figures.

FIG. 1 is a block diagram of an exemplary embodiment of a speech-assisted test system.

FIG. 2 is a block diagram of another exemplary embodiment of a speech-assisted test system.

FIG. 3 is a flowchart of an exemplary embodiment of a speech-assisted test method.

FIG. 4 is a flowchart of another exemplary embodiment of a speech-assisted test method, according to another exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the s described herein. However, it will be understood by those of ordinary skill in the art that the s described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the s described herein.

A definition that applies throughout this disclosure will now be presented.

The term “comprising” means “including, but not necessarily limited to”; it specifically indicates open-ended inclusion or membership in a so-described combination, group, series, and the like.

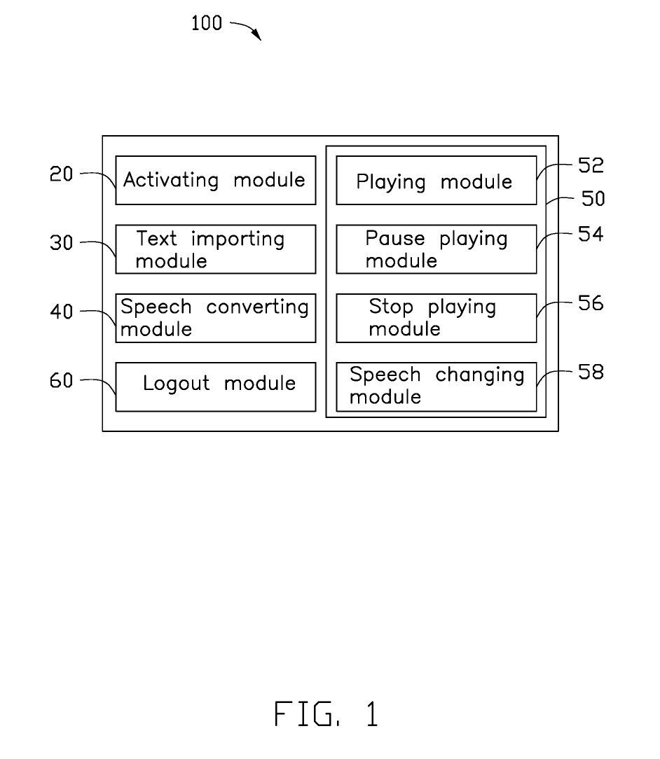

FIG. 1 illustrates an exemplary embodiment of a spoken testing system (speech-assisted test system 100) which includes an activating module 20, a text importing module 30, a speech converting module 40, a speech playing module 50, and a logout module 60. The speech-assisted test system 100 is employed in, for example, an electronic device to assist a tester in testing a product.

Upon activating the speech-assisted test system 100 operation, the activating module 20 displays an interactive interface on a display of the electronic device.

An import testing manual operation can be performed on the interactive interface. According to a selection of a testing manual of a tester, the text importing module 30 imports the testing manual to the speech-assisted test system 100. The testing manual may be input by the tester or may be given by a manufacturer of the product. The testing manual includes at least one testing procedures. In an exemplary embodiment, the testing manual is displayed on a preset blank area of the interactive interface.

The speech converting module 40 is configured to convert the contents of the testing manual to speech. In an exemplary embodiment, the speech converting module 40 converts the contents of the testing manual to speech through Text to Speech (TTS) technique.

According to a speech controlling operation of the tester on the interactive interface, the speech controlling module 50 determines the relevant speech file to play. While the speech file plays, the tester can test the product.

According to a logout operation on the interactive interface, the logout module 60 closes the interactive interface.

The speech controlling module 50 includes a playing module 52, a pause playing module 54, a stop playing module 56, and a speech changing module 58.

Upon a playback operation on the interactive interface, the playing module 52 plays the speech file and outputs the speech through an audio output device. The audio output device may be a loudspeaker.

According to a pause playback operation of the tester on the interactive interface, the pause playing module 54 pauses playback of the speech file. According to a resume playing operation in the interactive interface given to the pause playing module 54, the pause playing module 54 resumes playback of the speech file from where it was paused. Thus, the pause playing operation and the resume playing operation may be operated through a same icon on the interactive interface.

According to a stop playing operation on the interactive interface, the stop playing module 56 stops playback of the speech file.

According to a change operation on the interactive interface, the speech changing module 58 changes to and plays the next speech file.

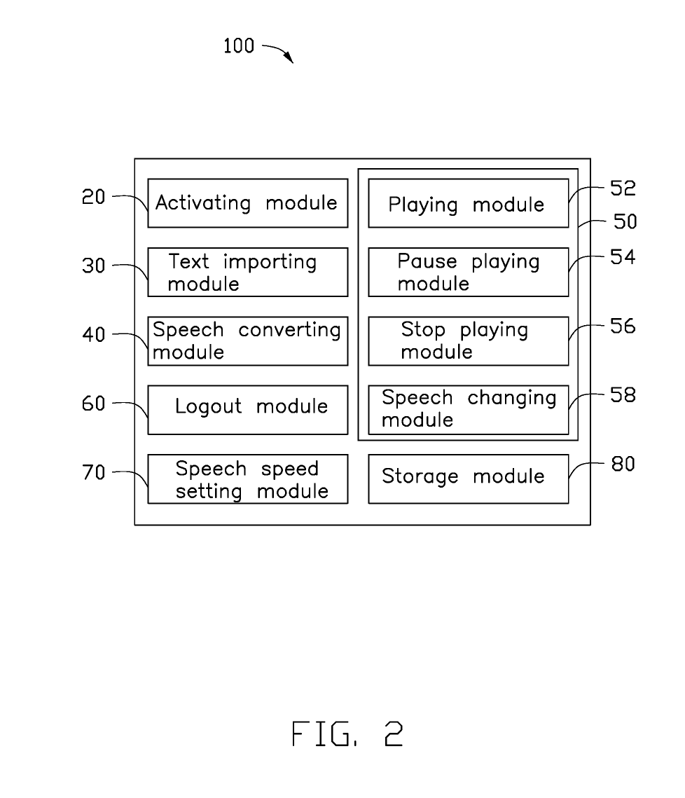

FIG. 2 illustrates a speech-assisted test system 100 according to another exemplary embodiment. The speech-assisted test system 100 further includes a speech speed setting module 70 and a storage module 80.

According to a speech speed setting operation on the interactive interface, the speech speed setting module 70 displays a speech speed setting interface. The tester inputs a required speech speed on the speech speed setting interface, and the speed setting module 70 sets the speed of the speech playback according to the input of the tester. The speech speed may be for example five words per second.

According to a storing operation on the interactive interface, the storage module 80 stores the speech file to a preset location. The preset location may be a memory of the electronic device or a file storage area on network.

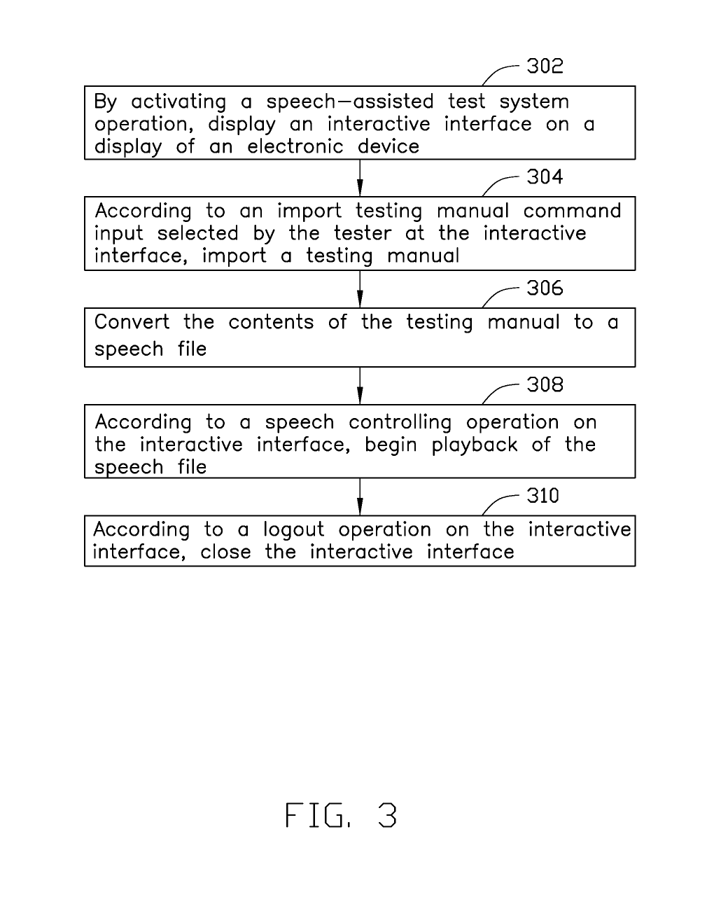

FIG. 3 illustrates an exemplary embodiment of a speech-assisted test method. The order of blocks in FIG. 3 is illustrative only and the order of the blocks can change. Additional blocks can be added or fewer blocks may be utilized without departing from this disclosure. The exemplary method begins at block 302.

At block 302, by activating a speech-assisted test system operation, the activating module 20 displays an interactive interface on a display of an electronic device.

At block 304, according to an import testing manual command input selected by the tester at the interactive interface, the text importing module 30 imports a testing manual. In an exemplary embodiment, the testing manual is displayed on a preset blank area of the interactive interface.

At block 306, the speech converting module 40 converts the contents of the testing manual to a speech file. In an exemplary embodiment, the speech converting module 40 converts the contents of the testing manual to speech through Text to Speech (TTS) technique. The speech includes a number of test steps.

At block 308, according to a speech controlling operation on the interactive interface, the speech controlling module 50 may begin playback of the speech file.

Block 308 includes following steps: according to a playback command on the interactive interface, the playing module 52 plays the speech file and outputs speech from the speech file through an audio output device. A pause playing command on the interactive interface makes the pause playing module 54 pause playback of the speech file. A resume playing operation in the interactive interface can make the pause playing module 54 resume playback of the speech file. A stop playing operation input on the interactive interface makes the stop playing module 56 stop playback of the speech file. A change operation on the interactive interface makes the speech changing module 58 play the next speech file.

At block 310, according to a logout operation on the interactive interface, the logout module 60 allows a user to close the interactive interface.

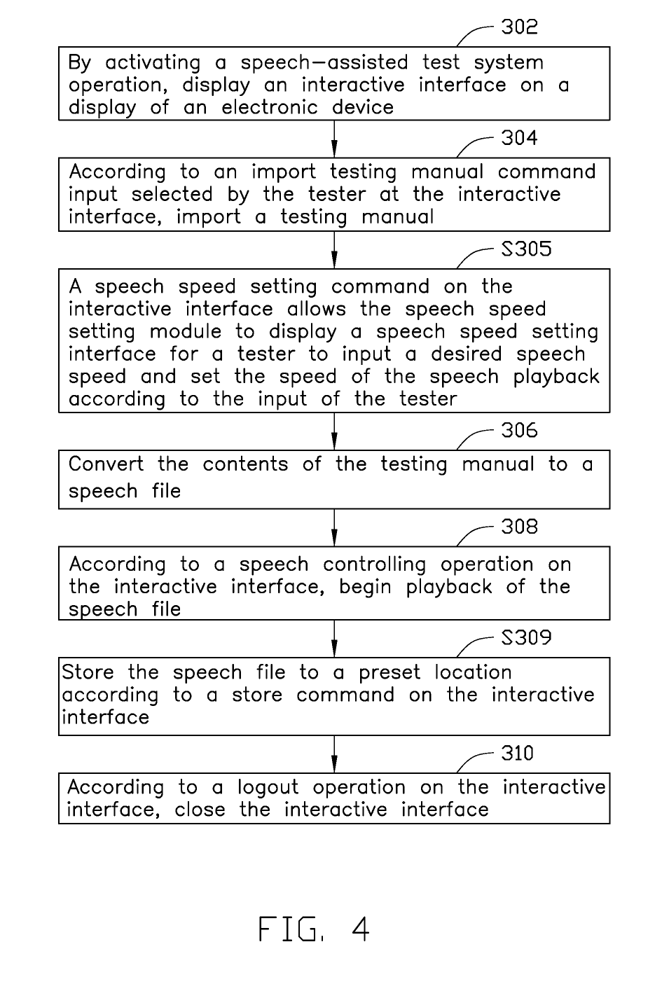

FIG. 4 illustrates another exemplary embodiment of the speech-assisted test method, the speech-assisted test method further includes blocks 305 and 309.

At block 305, a speech speed setting command on the interactive interface allows the speech speed setting module 70 to display a speech speed setting interface for a tester to input a desired speech speed and set the speed of the speech playback according to the input of the tester. The speech speed may be five words per second for example.

At block 309, the storage module 80 stores the speech file to a preset location according to a store command on the interactive interface. The preset location may be a memory of the electronic device or a file storage area on network.

The shown and described above are only examples. Even though numerous characteristics and advantages of the present disclosure have been set forth in the foregoing description, together with details of the structure and function of the present disclosure, the disclosure is illustrative only, and changes may be made in the detail, comprising in matters of shape, size, and arrangement of the parts within the principles of the present disclosure, up to the full extent established by the broad general meaning of the terms used in the claims.

What is claimed is:

1. A speech-assisted test system for an electronic device to assist in product testing, the speech-assisted test system comprising:
an activating module configured to, according to an activating the speech-assisted test system operation, display an interactive interface on a display of the electronic device;
a text importing module configured to, according to an import testing manual operation on the interactive interface, import a test testing manual to the speech-assisted test system;
a speech converting module configured to convert the contents of the testing manual to a speech file; and
a speech controlling module configured to, according to a speech controlling operation on the interactive interface, control the playback of the speech file.

2. The speech-assisted test system as claimed in claim 1, further comprising:
a logout module configured to, according to a logout operation on the interactive interface, close the interactive interface.

3. The speech-assisted test system as claimed in claim 1, further comprising:
a speech speed setting module configured to, according to a speech speed setting operation on the interactive interface, display a speech speed setting interface for a tester to input a speech speed and set a speed of the speech playback according to the input of the tester.

4. The speech-assisted test system as claimed in claim 3, wherein the speech speed is five words per second.

5. The speech-assisted test system as claimed in claim 1, further comprising:
a storage module configured to, according to a storing operation on the interactive interface, store the speech file to a preset position.

6. The speech-assisted test system as claimed in claim 5, wherein the preset position is a memory of the electronic device.

7. The speech-assisted test system as claimed in claim 5, wherein the preset position is a file storage area on network.

8. The speech-assisted test system as claimed in claim 1, wherein the testing manual comprises a plurality of testing procedures.

9. The speech-assisted test system as claimed in claim 1, wherein the speech controlling module comprises a playing module and a stop playing module, according to a playback operation on the interactive interface, the playing module plays the speech file and outputs the speech through an audio output device, according to a stop playing operation on the interactive interface, the stop playing module stops playback of the speech file.

10. The speech-assisted test system as claimed in claim 9, wherein the speech controlling module further comprises a pause playing module, according to a pause playback operation on the interactive interface, the pause playing module pauses playback of the speech file, according to a resume playing operation in the interactive interface, the pause playing module resumes playback of the speech file.

11. The speech-assisted test system as claimed in claim 10, wherein the pause playing operation and the resume playing operation operate on a same icon on the interactive interface.

12. The speech-assisted test system as claimed in claim 9, wherein the speech-assisted test system further comprises a speech changing module; wherein according to a changing operation on the interactive interface, the speech changing module changes and plays next speech file.

13. A speech-assisted test method for assisting testing, the speech-assisted test method comprising:
according to an activating speech-assisted test system operation, displaying an interactive interface on a display of an electronic device;
according to an import testing manual operation on the interactive interface, importing a testing manual;
converting contents in the testing manual to a speech file; and
according to a speech controlling operation on the interactive interface, determining the playback of the speech file.

14. The speech-assisted test method as claimed in claim 13, further comprising:
according to a logout operation on the interactive interface, closing the interactive interface.

15. The speech-assisted test method as claimed in claim 13, further comprising:
according to a speech speed setting operation on the interactive interface, displaying a speech speed setting interface for a tester to input a speech speed and setting a speed of the speech playback according to the input of the tester.

16. The speech-assisted test method as claimed in claim 15, wherein the speech speed is five words per second.

17. The speech-assisted test method as claimed in claim 13, further comprising:
according to a storing operation on the interactive interface, storing the speech file to a preset position.

18. The speech-assisted test method as claimed in claim 17, wherein the preset position is a memory of the electronic device.

19. The speech-assisted test method as claimed in claim 17, wherein the preset position is a file storage area on network.

20. The speech-assisted test method as claimed in claim 13, wherein the test testing manual comprises a plurality of testing procedures.
